(19) United States
(12) Patent Application Publication
(10) Pub. No.: US 2026/0276809 A1
(43) Pub. Date: Sep. 17, 2026

(54) TRAILER MEASUREMENT SYSTEM FOR A TOWING VEHICLE

(71) Applicant: Honda Motor Co., Ltd., Tokyo (JP)

(72) Inventor: Brian Karl Lickfelt, Powell, OH (US)

(21) Appl. No.: 19/080,688

(22) Filed: Mar. 14, 2025

(51) Int. Cl. G01S 13/76; G01S 13/02; H04W 4/80

(52) U.S. Cl. CPC G01S 13/765; G01S 13/0209; H04W 4/80

(57) ABSTRACT

A system for determining a position of a location on a trailer relative to a towing vehicle. The system includes a controller and a portable device having a first and second transceivers. The controller prompts a user to position the portable device in alignment with the location and instructs the first transceiver to transmit a first type of wireless signal to the towing vehicle when the portable device is positioned in alignment with the location. The controller instructs the second transceiver to transmit a second type of wireless signal to be received by ultrawide band transceivers of the towing vehicle. Moreover, the controller determines the position of the location on the trailer relative to the towing vehicle based on time of flight of the second type of wireless signal between the second transceiver and the ultrawide band transceivers when the portable device is positioned in alignment with the location.

### BACKGROUND

The disclosed subject matter relates generally to a measurement system. More particularly, the disclosed subject matter relates to a measurement system for measuring at least one dimension of a trailer attached to a towing vehicle.

For automated driving features related to trailer towing, for example, remote parking a trailer, or automated trailer backup assist, to work properly, it is important to know the length of the trailer when connected to a towing vehicle, and also the axle position of the trailer. Currently, a user measures the length of the trailer, and distance to axle with a tape measure, and then manually inputs that data into the towing vehicle systems, which is cumbersome and potentially prone to errors.

### SUMMARY

In accordance with one embodiment of the present disclosure, a measurement system for determining a position of a first predefined location on a trailer attached to a towing vehicle relative to the towing vehicle is provided. The towing vehicle includes a vehicle body and a plurality of ultrawide band transceivers mounted to the vehicle body. The measurement system includes a portable device and a controller. The portable device is associated with the towing vehicle and includes a user interface, a first transceiver, and a second transceiver, wherein the second transceiver includes an ultrawide band transceiver. The controller is communicatively coupled to the user interface, the first transceiver, and the second transceiver. The controller is configured to prompt a user, via the user interface, to position the portable device in alignment with the first predefined location on the trailer and instruct the first transceiver of the portable device to transmit a first type of wireless signal to the towing vehicle upon receiving a confirmation from the user, via the user interface, that the portable device is positioned in alignment with the first predefined location. Further, the controller is configured to instruct the second transceiver to transmit a second type of wireless signal to be received by the ultrawide band transceivers of the towing vehicle. Also, the controller is configured to determine the position of the first predefined location on the trailer relative to the towing vehicle based on time of flight of the second type of wireless signal between the second transceiver of the portable device and the plurality of ultrawide band transceivers of the towing vehicle.

In accordance with another embodiment of the present disclosure, a portable device to facilitate determination of a position of one or more predefined locations on a trailer with respect to a towing vehicle towably coupled to the trailer is disclosed. The portable device includes a user interface, a first transceiver, and a second transceiver. The second transceiver includes an ultrawide band transceiver. Further, the portable device includes a controller. The controller is communicatively coupled to the user interface, the first transceiver, and the second transceiver. Also, the controller is configured to prompt a user, via the user interface, to position the portable device in alignment with a first predefined location of the one or more predefined locations on the trailer and instruct the first transceiver to transmit a first type of wireless signal to the towing vehicle upon receiving a confirmation from the user, via the user interface, that the portable device is positioned in alignment with the first predefined location. Further, the controller is configured to instruct the second transceiver to transmit a second type of wireless signal to be received by ultrawide band transceivers mounted to a vehicle body of the towing vehicle. Moreover, the controller is configured to determine the position of the first predefined location on the trailer relative to the towing vehicle based on time of flight of the second type of wireless signal between the second transceiver and the ultrawide band transceivers.

In accordance with yet another embodiment of the present disclosure, a method for measuring a position of a predefined location on a trailer from a towing vehicle is disclosed. The trailer is coupled to a rear end of the towing vehicle and extends rearwardly of the rear end of the towing vehicle. The method includes prompting, via a user interface of a portable device, a user to position the portable device in alignment with the predefined location on the trailer. The portable device includes at least one ultrawide band transceiver. The method includes transmitting, by at least one transceiver of the portable device, a first type of wireless signals from the portable device to wake one or more systems of the towing vehicle upon receiving a confirmation from the user, via the user interface, that the portable device is positioned in alignment with the predefined location. Further, the method includes transmitting second type of wireless signals by at least one ultrawide band transceiver of the portable device to be received by ultrawide band transceivers mounted to a vehicle body of the towing vehicle. Also, the method includes determining a position of the predefined location on the trailer relative to the towing vehicle based on time of flight of the transmitted second type of wireless signals.

### BRIEF DESCRIPTION OF THE DRAWINGS

Certain embodiments of the present disclosure will be better understood from the following description taken in conjunction with the accompanying drawings in which:

FIG. 1 is a schematic view of a towing vehicle and a trailer attached to the towing vehicle, a user standing in alignment with an axle of the trailer and having a portable device to measure a distance of the axle relative to a rear end of the towing vehicle, in accordance with one embodiment of the present disclosure;

FIG. 2 is a schematic view of a towing vehicle and a trailer attached to the towing vehicle, a user standing in alignment with a back end of the trailer and having a smart phone to measure a distance of the back end relative to the rear end of the towing vehicle, in accordance with one embodiment of the present disclosure; and

FIG. 3 is a block diagram that illustrates a measurement system that facilitates a measurement of trailer length and a distance of the axle of the trailer relative to the rear end of the towing vehicle, in accordance with one embodiment of the present disclosure.

### DETAILED DESCRIPTION OF EXEMPLARY EMBODIMENTS

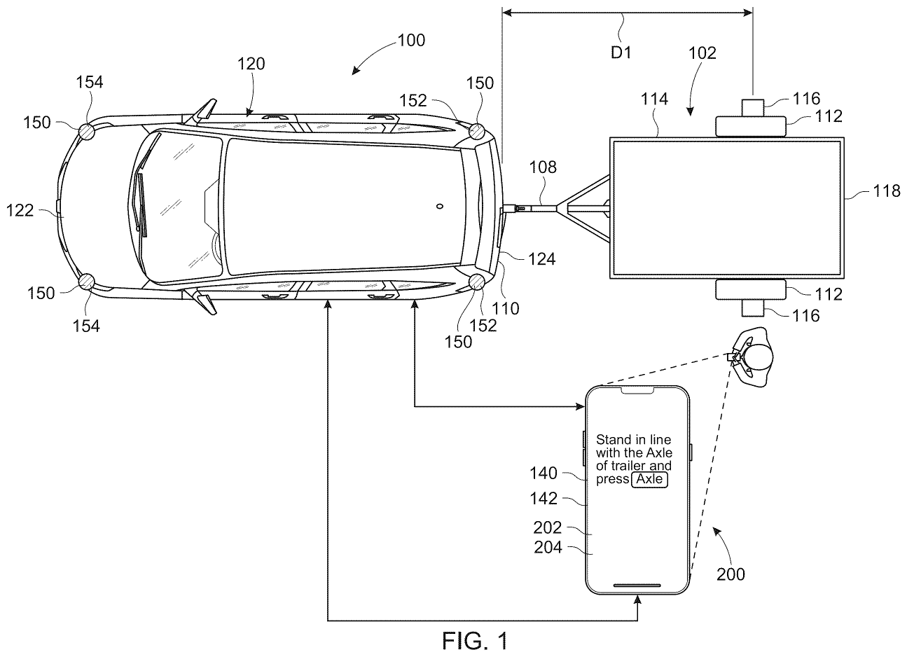

A few inventive aspects of the disclosed embodiments are explained in detail below with reference to the various figures. Exemplary embodiments are described to illustrate the disclosed subject matter, not to limit its scope, which is defined by the claims. Those of ordinary skill in the art will recognize a number of equivalent variations of the various features provided in the description that follows. Embodiments are hereinafter described in detail in connection with the views and examples of FIGS. 1-3, wherein like numbers indicate the same or corresponding elements throughout the views.

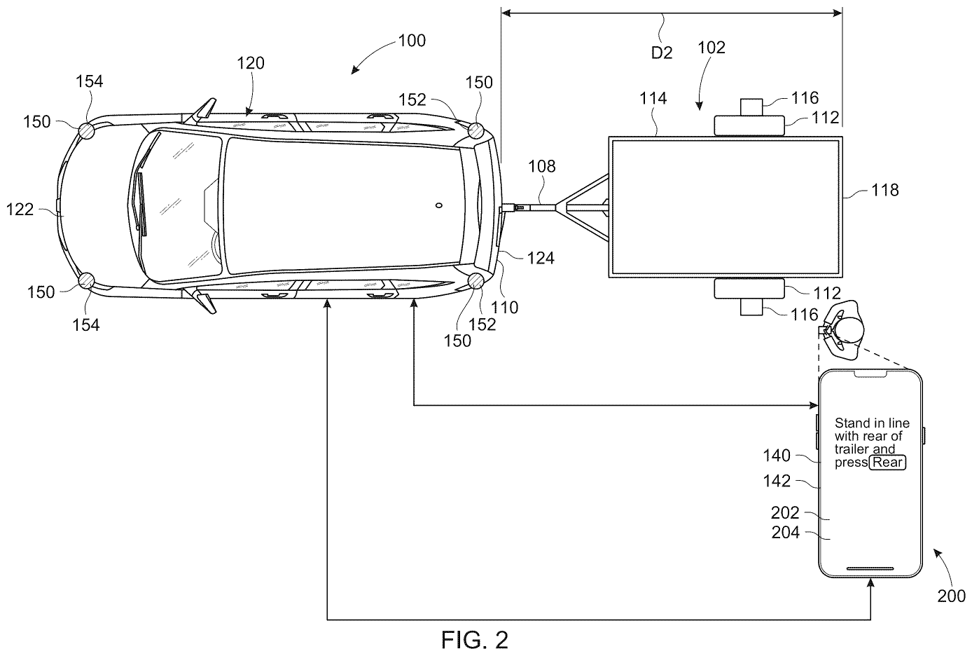

FIGS. 1 and 2 illustrate a schematic top view of a vehicle (also referred to as a towing vehicle), indicated generally at 100. The towing vehicle 100 is coupled, e.g., towably coupled, to a trailer 102. The trailer 102 is arranged rearwardly of the towing vehicle 100 and is removably coupled to the towing vehicle 100, using known couplers, for example, a trailer hitch that includes a ball mount. The trailer 102 is pivotally attached to the towing vehicle 100 and is configured to pivot about a vertical axis that extends substantially perpendicularly to a ground surface on which the towing vehicle 100 and the trailer are stationed. As shown in FIGS. 1 and 2, the trailer 102 extends rearwardly of the towing vehicle 100 and includes a front end portion 108, for example, a tow arm portion 108, which is hinged/hitched to a rear end portion 110 of the towing vehicle 100. In other words, the trailer 102 is attached to the rear end portion 110 of the towing vehicle 100. Further, the trailer 102 includes a plurality of trailer wheels 112, for example, the pair of wheels 112, supported on a frame 114 of the trailer 102 to support the trailer 102 on the ground surface. The wheels 112 are connected to each other via an axle 116. Although a single axle 116 is shown, the trailer 102 may include multiple axles.

As shown in FIGS. 1 and 2, the towing vehicle 100 is configured to move the trailer 102. The towing vehicle 100 includes a vehicle body 120 extending from a front end 122 of the towing vehicle 100 to a rear end 124 of the towing vehicle 100. The vehicle body 120 supports various components of the towing vehicle 100. As an example, the vehicle body 120 supports wheels of the towing vehicle 100 that allow the vehicle body 120 to be moved with respect to the ground surface. To power the towing vehicle 100 and to enable the movement of the wheels of the towing vehicle 100 over the ground surface, the towing vehicle 100 includes a power source (not shown) operatively coupled to the wheels to provide power to the wheels. The power source may include one or more of an internal combustion engine, an electric motor (e.g., running on a battery), and/or any other propulsion system applicable for powering motion of a towing vehicle, now known or in the future developed.

Further, the towing vehicle 100 includes a plurality of ultrawide band transceivers 150, mounted to the vehicle body 120. The ultrawide band transceivers 150 are arranged at various locations of the vehicle body 120. In some embodiments, the ultrawide band transceivers 150 includes at least one rear ultrawide band transceiver 152, for example, two rear ultrawide band transceivers 152, arranged at the rear end 124 of the towing vehicle 100 and located at rear corners of the towing vehicle 100, as shown. Further, the ultrawide band transceivers 150 includes at least one front ultrawide band transceiver 154, for example, two front ultrawide band transceivers 154, arranged at the front end 122 of the towing vehicle 100 and located at front corners of the towing vehicle 100, as shown. The ultrawide band transceivers 150 may be arranged at any location on the towing vehicle 100 and the locations of the ultrawide band transceivers 150 described above are exemplary. The locations of the ultrawide band transceivers 150 may be stored in a memory of the towing vehicle 100.

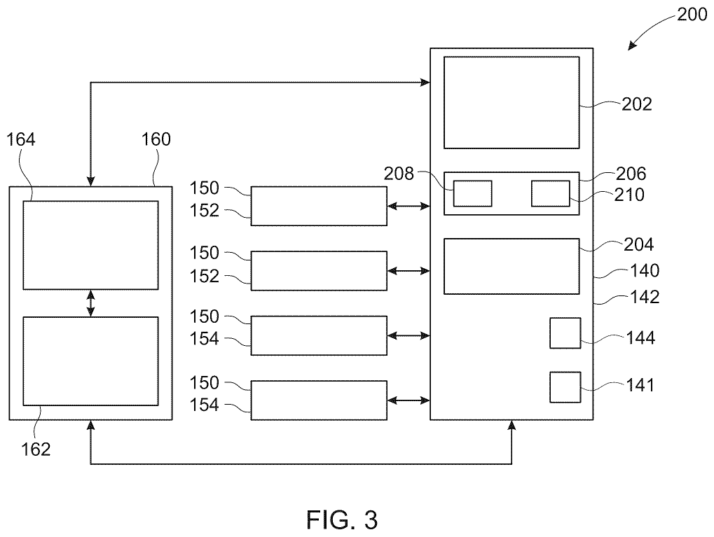

With continued reference to FIGS. 1 and 2, and in conjunction with FIG. 3, the towing vehicle 100 includes a controller 160 (see FIG. 3). The controller 160 may include a processor 162 and a memory 164. In some optional embodiments, the processor 162 and/or the memory 164 may be provided outside the controller 160. The controller 160 may facilitate control of various control systems (e.g., trailer control systems, vehicle safety systems, vehicle dynamic control systems, remote systems) associated with the towing vehicle 100. In some embodiments, the controller 160 may be configured to access locations of the ultrawide band transceivers 150 from the memory 164.

A measurement system 200 is further discussed. The measurement system 200 includes a portable device 140 and a controller 206. The measurement system 200 is configured to determine a position of one or more predefined locations on the trailer 102 relative to the towing vehicle 100 and/or facilitate determination of at least one dimension, e.g., a length, of the trailer 102 based on input received from the ultrawide band transceivers 150 of the towing vehicle 100 and the one or more transceivers (discussed below) of the portable device 140. As an example, a first predefined location corresponds to the axle 116 of the trailer 102 and a second predefined location corresponds to a back end 118 of the trailer 102. Although not limited, the measurement system 200 may also include the controller 160 of the towing vehicle 100 and the ultrawide band transceivers 150 mounted to the vehicle body 120.

The portable device 140 is configured to provide authentication data to the towing vehicle 100 and facilitate determination of a position of one or more predefined locations on the trailer 102 with respect to a towing vehicle 100. In the exemplary embodiment, the portable device 140 is a hand-held device, such as a smart phone 142. In other embodiments, portable device 140 may also be a cellular phone, a key fob, and/or any other type of authorization/authentication device that allows the measurement system 200 to function as described herein. The portable device 140 is configured to facilitate the authentication of the user by sharing or transmitting an authentication signal/message/data to the towing vehicle 100. In an embodiment, the portable device 140 includes hardware and software to facilitate communication with the towing vehicle 100. In some embodiments, the portable device 140 may include a first transceiver 141, which may include a Bluetooth transceiver and/or a Near Field Communication (NFC) transceiver for data transmission. In some embodiments, the portable device 140 may include a second transceiver 144, which may include at least one ultrawide band transceiver, as shown in FIG. 3, that enables a radio frequency based short range communication between the portable device 140 and the towing vehicle 100. In an embodiment, the portable device 140 includes a digital key for the towing vehicle 100 to enable an opening, a closing, and/or a starting of the towing vehicle 100.

In the exemplary embodiment, the portable device 140 may include a user interface 202. In some embodiments, the user interface 202 may be stored on a server (not shown), and which may include and/or be accessed via a web-based application 204 installed on the portable device 140, e.g., when the portable device 140 includes the smart phone 142 or a similar device. The user interface 202 can be displayed on a display device of the smart phone 142 and facilitates an interaction of a controller 206 of the measurement system 200 with a user. The user interface 202 may also be used to provide instructions to the user and/or to receive input from the user to enable the determination of the various dimensions, for example, a length, etc., of the trailer 102 attached to the towing vehicle 100.

The controller 206 is communicatively coupled to the user interface 202, the first transceiver 141, and the second transceiver 144. The controller 206 is included within the portable device 140, although, in some embodiments, the controller 206 may be included within the towing vehicle 100. The controller 206 is configured to communicate with the controller 160 of the towing vehicle 100 and share data related to the trailer 102 (e.g., data related to one or more predefined locations of the trailer 102) to the controller 160 of the towing vehicle 100. To this end, the controller 206 is configured to determine at least one of a distance between the axle 116 of the trailer 102 and the rear end 124 of the towing vehicle 100 and a length of the trailer 102 based on the determined positions of the first predefined location and the second predefined location relative to the towing vehicle 100. In some embodiments, the controller 206 may use a transceiver of the portable device 140 to share such data to the controller 160 of the towing vehicle 100. In some embodiments, the controller 206 may facilitate an establishment of a connection between the portable device 140 and the controller 160 of the towing vehicle 100 by sharing an authorization signal for authenticating the portable device 140 with the towing vehicle 100. Also, the controller 206 may initiate a length measurement process upon authenticating the portable device 140 with the towing vehicle 100. While concepts of the present disclosure relate to the controller 206 being on-board the portable device 140, in some embodiments, the controller 206 may be outside the portable device 140, as well.

In some embodiments, the controller 206 includes a processor 208 and a memory 210, as shown in FIG. 3, to respectively process and store data or requests received from the user interface 202 or from elsewhere. Further, the processor 208 may also instruct the first transceiver 141 and/or the second transceiver 144 to transmit various types of wireless signals. For example, the first transceiver 141 may be instructed to transmit a first type of wireless signal to the towing vehicle 100 or to the controller 160 of the towing vehicle 100 and the second transceiver 144 may be instructed to transmit second type of wireless signals to the ultrawide band transceivers 150. In some embodiments, such instructions may be stored in the memory 210 and may be delivered to the first transceiver 141 and the second transceiver 144 in response to data or requests received from the user interface 202. Moreover, the notification or prompts that are displayed to the user via the portable device 140, e.g., through the user interface 202, during measurement process may be stored inside the memory 210.

The memory 210 may be integrated into the controller 206, but those skilled in the art will understand that the memory 210 may be separate from the controller 206, while still being associated with and accessible by the controller 206 to store information in and retrieve information from the memory 210 as necessary. Although the processor 208 is contemplated, it is also possible and contemplated to use other electronic components such as a microcontroller, an application specific integrated circuit (ASIC) chip, or any other integrated circuit device. The processor 208 is configured to execute instructions, which controls and monitors various functions associated with measure of the distances of one or more predefined locations of the trailer 102 relative to the rear end 124 of the towing vehicle 100.

For initiating the distance/length measurement process of one or more predefined locations, for example, the axle 116 and the back end 118, of the trailer 102 relative to the rear end 124 of the towing vehicle 100, the controller 206, upon receipt of a request from the user, e.g., via the user interface 202, may activate the second transceiver 144 of the portable device 140, causing the second transceiver 144 to transmit radio signals (e.g., the second type of wireless signals). Before initiating the transmission of the radio signals or the second type of wireless signals, the controller 206 may prompt the user, via the user interface 202 and through the web-based application 204, to stand in alignment with the axle 116 of the trailer 102 (e.g., the first predefined location), as shown in FIG. 1, and to provide a confirmation, via the user interface 202, that the user is standing approximately in alignment with the axle 116 of the trailer 102 (or the first predefined location). It should be understood that approximately in alignment with the axle 116 may also be referred to or described as the portable device 140 being positioned nearby an end of the axle 116. Furthermore, the instructions to the user may also include a statement that if the trailer 102 includes multiple axles, then the user should position the portable device 140 approximately at a mid-point between the multiple axles.

The user may provide such a confirmation by pressing a virtual button on the user interface 202, as provided by the web-based application 204. To this end, the controller 206 may instruct and/or initiate the transmission of the first type of wireless signal from the portable device 140 by the first transceiver 141 to wake one or more systems of the towing vehicle 100 upon receiving the confirmation from the user, via the user interface 202, that the portable device 140 is positioned in alignment with the first predefined location. Upon receipt of such confirmation from the user, the controller 206 may further instruct and/or initiate the transmission of radio signals or the second type of wireless signals from the second transceiver 144 to be received by the ultrawide band transceivers 150 mounted on the towing vehicle 100. Such transmission may occur when the portable device 140 remains in alignment with the first predefined location.

Each of the ultrawide band transceivers 150 mounted on the towing vehicle 100 receives the signals transmitted by the second transceiver 144, and reflects back the signal to the second transceiver 144. It may be appreciated that the controller 206 determines a distance, D1 (see FIG. 1), of each of the ultrawide band transceivers 150 mounted on the towing vehicle 100 from the portable device 140 based on the time of flight calculation, e.g., a time taken between the transmission of the second type of wireless signals from the second transceiver 144 and the receipt of a corresponding reflected signals by the second transceiver 144. In some embodiments, the time of flight can merely correspond to a time taken for the second type of wireless signals to be transmitted from the second transceiver 144 and be received by ultrawide band transceivers 150 on the towing vehicle 100. Moreover, the controller 206 detects the locations of the ultrawide band transceivers 150 based on input received from the memory 164 and/or the controller 160, and, accordingly, determines the distance, D1, of the axle 116 from the rear end 124 of the towing vehicle 100 based on the locations of the ultrawide band transceivers 150 and determined distance, D1, of each of the ultrawide band transceivers 150 from the portable device 140 (e.g., from the second transceiver 144 of the portable device 140).

Upon determining the distance, D1, i.e., the position of the axle 116 relative to the rear end 124 of the towing vehicle 100, or otherwise, the controller 206 prompts the user, via the user interface 202, accessed via the web-based application 204 installed on the smart phone 142, to move to a location in alignment with the back end 118 of the trailer 102 (e.g., the second predefined location), as shown in FIG. 2, and prompts the user to confirm whether the user is standing approximately in alignment with the back end 118 of the trailer 102. Upon receipt of the confirmation from the user, the controller 206 may instruct and/or initiate the transmission of radio signals or the second type of wireless signals from the second transceiver 144 of the portable device 140 to be received by the ultrawide band transceivers 150 mounted on the towing vehicle 100. The ultrawide band transceivers 150 mounted on the towing vehicle 100 receives (e.g., correspondingly receives) the second type of wireless signals transmitted by the second transceiver 144 and reflects back the second type of wireless signals to the second transceiver 144. It may be noted that the controller 206 is configured to provide, via the user interface 202, a position confirmation screen to the user, and receive the confirmation of positioning the portable device 140 at the first predefined location and/or the second predefined location from the user via the position confirmation screen.

It may be appreciated that the controller 206 determines distance of each of the ultrawide band transceivers 150 mounted on the towing vehicle 100 from the portable device 140 based on the time of flight calculation, e.g., a time taken between the transmission of the radio signals or the second type of wireless signals from the second transceiver 144 and the receipt of a corresponding reflected signals by the second transceiver 144. In some embodiments, the time of flight can merely correspond to a time taken for the second type of wireless signals to be transmitted from the second transceiver 144 and be received by ultrawide band transceivers 150 on the towing vehicle 100. Upon determining the distances of the first ultrawide band transceivers 150 from the portable device 140, the controller 206 determines the distance, D2 (see FIG. 2), of the back end 118 of the trailer 102 from the rear end 124 of the towing vehicle 100 based on the location of the ultrawide band transceivers 150 on the towing vehicle 100 and determined distances, D2, of the ultrawide band transceivers 150 from the portable device 140 of each of the ultrawide band transceivers 150 from the portable device 140 (e.g., from the second transceiver 144 of the portable device 140).

In an alternative embodiment, the measurement system 200 may instruct the user to position the portable device 140 at additional positions of the trailer 102, for example, first at a first wheel of the trailer 102, second at a first rear corner of the trailer 102, third at a second rear corner of the trailer 102, and fourth at a second wheel of the trailer 102. The controller 206 may calculate an average of such measurements to determine a distance from the rear end 124 of the towing vehicle 100 to the back end 118 of the trailer 102, and a distance from the rear end 124 of the towing vehicle 100 and the axle 116. In these manners, the measurement system 200 and/or the portable device 140 facilitates determining the distance of the axle 116 from the rear end 124 of the towing vehicle 100 as well as a dimension, such as a total length, of the trailer 102. In some embodiments, the controller 206 is configured to share the measured data about the trailer 102 with the controller 160 and/or with systems within the towing vehicle 100 that benefit from such information (e.g., autonomous or semi-autonomous vehicle functions such as remote trailer parking or trailer backup assist).

Although the second transceiver 144 is contemplated to transmit and receive the reflected radio signals or second type of wireless signals from the ultrawide band transceivers 150, it may be appreciated that the controller 206 may, in reverse, control the ultrawide band transceivers 150 to transmit the radio signals to the second transceiver 144 and receive the reflected radio signals from the second transceiver 144. Further, in some embodiments, the time of flight calculations, based on the input received from the second transceiver 144 (and/or the ultrawide band transceivers 150) are performed by the controller 160. In such a case, the controller 206 (or its application) may be omitted, and the controller 160 may perform the equivalent functions of the controller 206 as have been described herein, e.g., to communicate with the user interface 202 (i.e., through the web-based application 204) to facilitate the user to enable measuring the distance of axle 116, the back end 118 of the trailer 102, and/or any other predefined location of the trailer 102 relative to the rear end 124 of the towing vehicle 100.

The foregoing description of embodiments and examples has been presented for purposes of illustration and description. It is not intended to be exhaustive or to limit the disclosure to the forms described. Numerous modifications are possible in light of the above teachings. Some of those modifications have been discussed and others will be understood by those skilled in the art. The embodiments were chosen and described in order to best illustrate certain principles and various embodiments as are suited to the particular use contemplated. The scope of the disclosure is, of course, not limited to the examples or embodiments set forth herein, but can be employed in any number of applications and equivalent devices by those of ordinary skill in the art. Rather it is hereby intended that the scope of the disclosure be defined by the claims appended hereto.

What is claimed is:

1. A measurement system for determining a position of a first predefined location on a trailer attached to a towing vehicle relative to the towing vehicle, wherein the towing vehicle includes a vehicle body and a plurality of ultrawide band transceivers mounted to the vehicle body, the measurement system comprising:
a portable device associated with the towing vehicle and including a user interface, a first transceiver, and a second transceiver, wherein the second transceiver comprises an ultrawide band transceiver; and
a controller communicatively coupled to the user interface, the first transceiver, and the second transceiver, the controller configured to:
prompt a user, via the user interface, to position the portable device in alignment with the first predefined location on the trailer,
instruct the first transceiver of the portable device to transmit a first type of wireless signal to the towing vehicle upon receiving a confirmation from the user, via the user interface, that the portable device is positioned in alignment with the first predefined location,
instruct the second transceiver of the portable device to transmit a second type of wireless signal to be received by the plurality of ultrawide band transceivers of the towing vehicle, and
determine the position of the first predefined location on the trailer relative to the towing vehicle based on time of flight of the second type of wireless signal between the second transceiver of the portable device and the plurality of ultrawide band transceivers of the towing vehicle.

2. The measurement system of claim 1, wherein the first predefined location corresponds to an axle of the trailer.

3. The measurement system of claim 1, wherein the controller is further configured to:
prompt the user, via the user interface, to position the portable device in alignment with a second predefined location on the trailer upon determining the position of the first predefined location on the trailer, and
instruct the second transceiver of the portable device to transmit second type of wireless signals to be received by the plurality of ultrawide band transceivers of the towing vehicle upon receiving a confirmation from the user, via the user interface, that the portable device is positioned in alignment with the second predefined location, and
determine a position of the second predefined location on the trailer relative to the towing vehicle based on time of flight of the second type of wireless signals between the second transceiver of the portable device and the plurality of ultrawide band transceivers of the towing vehicle.

4. The measurement system of claim 3, wherein the second predefined location corresponds to a back end of the trailer.

5. The measurement system of claim 4, wherein the controller is configured to determine at least one of a distance between the axle of the trailer and a rear end of the towing vehicle and a length of the trailer based on the determined positions of the first predefined location and the second predefined location relative to the towing vehicle.

6. The measurement system of claim 1, wherein the controller is included within the portable device.

7. The measurement system of claim 1, wherein the controller is included within the towing vehicle.

8. The measurement system of claim 1, wherein the portable device is a smart phone and the user interface includes a web-based application adapted to be installed on the smart phone.

9. The measurement system of claim 1, wherein the controller is configured to provide, via the user interface, a position confirmation screen to the user, and receive the confirmation of positioning the portable device at the first predefined location or the second predefined location from the user via the position confirmation screen.

10. The measurement system of claim 1, wherein the first transceiver includes a Bluetooth transceiver or a near field communication (NFC) transceiver.

11. A portable device to facilitate determination of a position of one or more predefined locations on a trailer with respect to a towing vehicle towably coupled to the trailer, the portable device including:
a user interface, a first transceiver, and a second transceiver, the second transceiver including an ultrawide band transceiver; and
a controller communicatively coupled to the user interface, the first transceiver, and the second transceiver, the controller configured to:
prompt a user, via the user interface, to position the portable device in alignment with a first predefined location of the one or more predefined locations on the trailer,
instruct the first transceiver to transmit a first type of wireless signal to the towing vehicle upon receiving a confirmation from the user, via the user interface, that the portable device is positioned in alignment with the first predefined location,
instruct the second transceiver to transmit a second type of wireless signal to be received by a plurality of ultrawide band transceivers mounted to a vehicle body of the towing vehicle, and
determine the position of the first predefined location on the trailer relative to the towing vehicle based on time of flight of the second type of wireless signal between the second transceiver and the plurality of ultrawide band transceivers of the towing vehicle.

12. The portable device of claim 11, wherein the first predefined location corresponds to an axle of the trailer.

13. The portable device of claim 11, wherein the controller is further configured to:
prompt the user, via the user interface, to position the portable device in alignment with a second predefined location of the one or more predefined locations on the trailer upon determining the position of the first predefined location on the trailer, and
instruct the second transceiver of the portable device to transmit second type of wireless signals to be received by the plurality of ultrawide band transceivers of the towing vehicle upon receiving a confirmation from the user, via the user interface, that the portable device is positioned in alignment with the second predefined location, and
determine a position of the second predefined location on the trailer relative to the towing vehicle based on time of flight of the second type of wireless signals between the second transceiver of the portable device and the plurality of ultrawide band transceivers of the towing vehicle.

14. The portable device of claim 13, wherein the second predefined location corresponds to a back end of the trailer.

15. The portable device of claim 14, wherein the controller is configured to determine at least one of a distance between the axle of the trailer and a rear end of the towing vehicle and a length of the trailer based on the determined positions of the first predefined location and the second predefined location relative to the towing vehicle.

16. The portable device of claim 11, wherein the controller is configured to provide, via the user interface, a position confirmation screen to the user, and receive the confirmation of positioning the portable device at the first predefined location or the second predefined location from the user via the position confirmation screen.

17. A method for measuring a position of a predefined location on a trailer relative to a towing vehicle, wherein the trailer is coupled to a rear end of the towing vehicle and extends rearwardly of the rear end of the towing vehicle, the method comprising:
prompting, via a user interface of a portable device, a user to position the portable device in alignment with the predefined location on the trailer, wherein the portable device includes at least one ultrawide band transceiver;
transmitting, by at least one transceiver of the portable device, a first type of wireless signal from the portable device to wake one or more systems of the towing vehicle upon receiving a confirmation from the user, via the user interface, that the portable device is positioned in alignment with the predefined location;
transmitting a second type of wireless signals by at least one ultrawide band transceiver of the portable device to be received by a plurality of ultrawide band transceivers mounted to a vehicle body of the towing vehicle; and
determining the position of the predefined location on the trailer relative to the towing vehicle based on time of flight of the transmitted second type of wireless signals.

18. The method of claim 17, wherein the predefined location is a first predefined location, and the method further includes:
prompting the user, via the user interface, to position the portable device in alignment with a second predefined location on the trailer upon determining a position of the first predefined location on the trailer,
transmitting the second type of wireless signals by the at least one ultrawide band sensors of the portable device to be received by the plurality of ultrawide band transceivers of the towing vehicle upon receiving a confirmation from the user, via the user interface, that the portable device is positioned in alignment with the second predefined location, and
determining a position of the second predefined location on the trailer relative to the towing vehicle based on time of flight of the second type of wireless signals between the at least one ultrawide band transceiver of the portable device and the plurality of ultrawide band transceivers of the towing vehicle.

19. The method of claim 18 further comprises determining at least one of a distance of the trailer relative to a rear end of the towing vehicle or a length of the trailer based on the determined positions of the first predefined location and the second predefined location relative to the towing vehicle.

20. The method of claim 18, wherein the first predefined location corresponds to an axle of the trailer and the second predefined location corresponds to a back end of the trailer.
